(19) United States
(12) Patent Application Publication
(10) Pub. No.: US 2013/0032639 A1
(43) Pub. Date: Feb. 7, 2013

(54) FUEL INJECTOR

(71) Applicant: Stephen C. HARDING, Bristol (GB)

(72) Inventor: Stephen C. HARDING, Bristol (GB)

(73) Assignee: ROLLS-ROYCE PLC, London (GB)

(21) Appl. No.: 13/540,941

(22) Filed: Jul. 3, 2012

(30) Foreign Application Priority Data
Aug. 4, 2011 (GB) 1113421.0

(51) Int. Cl. F02M 63/00

(52) U.S. Cl. 239/8; 239/533.2

(57) ABSTRACT

A fuel injector head for a gas turbine engine comprising: a pilot injector having a central axis, the pilot injector being arranged to direct fuel and air to a pilot combustion zone, a main injector located radially outwardly of the pilot injector and being arranged to direct fuel and air to a main combustion zone, a splitter separating the pilot injector from the main injector and comprising a body, the body defining an axis, an annular surface and a downstream edge wherein the annular surface has a circumferentially varied axial length so that interaction between the pilot combustion zone and the main combustion zone initiates from least two different axial positions.

This invention concerns fuel injector assemblies for gas turbine engines.

There is a continuing need, driven by environmental concerns and governmental regulations, for improving the efficiency of and decreasing the emissions from gas turbine engines of the type utilised to power jet aircraft, marine vessels or generate electricity. Particularly there is a continuing drive to reduce oxides of nitrogen (NOx) emissions.

Advanced gas turbine combustors must meet these requirements for lower NOx emissions under conditions in. which the control of NOx generation is very challenging. For example, the goal for the Ultra Efficient Engine Technology (UEET) gas turbine combustor research being done by NASA is a 70 percent reduction in NOx emissions and a 15 percent improvement in fuel efficiency compared to ICAO 1996 standards technology. Realisation of the fuel efficiency objectives will require an overall cycle pressure ratio as high as 60 to 1 and a peak cycle temperature of 1600 degrees centigrade or greater. The severe combustor pressure and temperature conditions required for improved fuel efficiency make the NOx emissions goal much more difficult to achieve.

Typical staged low NOx fuel injectors that seek to address this issue have concentrically arranged pilot and main injectors with the main injector surrounding the pilot injector. However, typical staged low NOx injector arrangements have several operational disadvantages, including for example, flame stability and re-light characteristics, the potential for excessive combustor dynamics or pressure fluctuations caused by combustor instability. Combustion instability occurs when the heat release couples with combustor acoustics such that random pressure perturbations in the combustor are amplified into larger pressure oscillations.

These large pressure oscillations, having amplitudes of about 1-5 percent of the combustor pressure, can have catastrophic consequences and thus must be reduced or eliminated.

The invention seeks to provide an improved injector that addresses these and other problems.

According to a first aspect of the present invention there is provided a fuel injector as claimed in any one of claims 1 to 4 and 7, a combustor as claimed in claims 5 and 7 and a method as claimed in claims 6 and 7.

Embodiments of the present invention will now be described by way of example only and with reference to the accompanying drawings, in which:

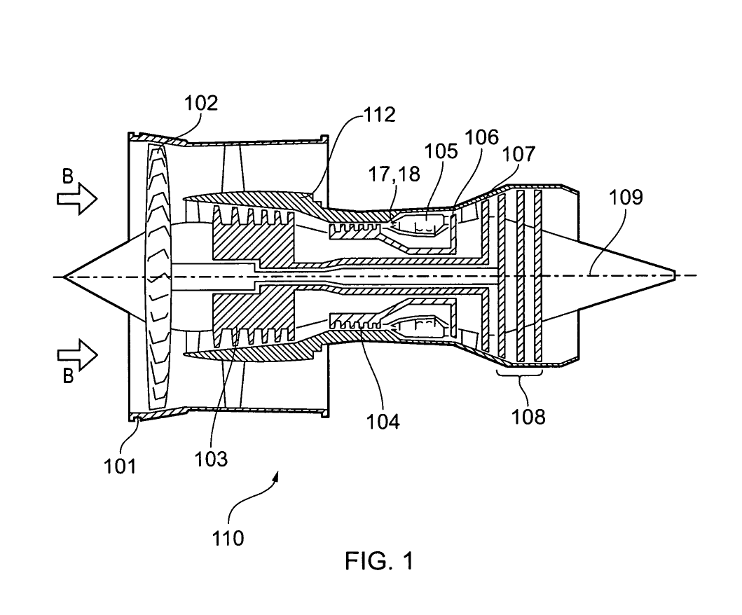

FIG. 1 depicts a general gas turbine engine section;

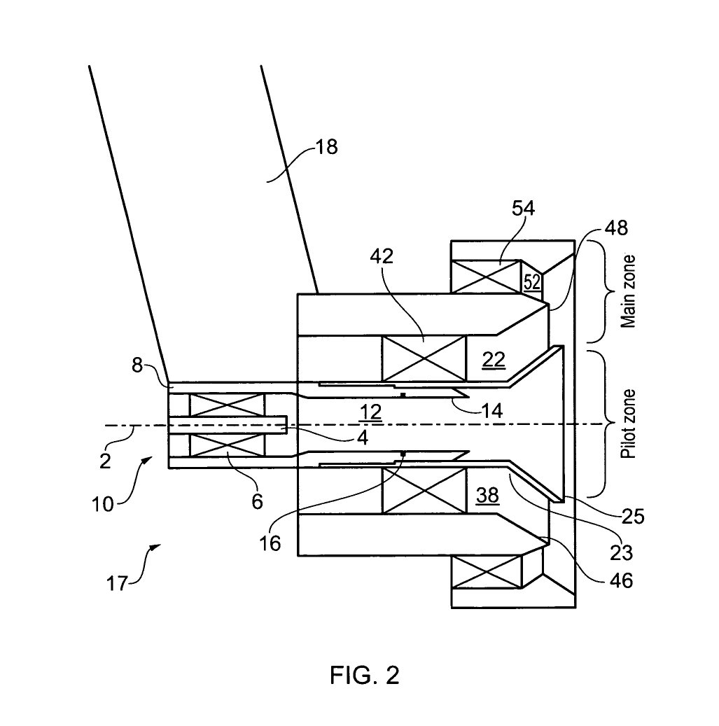

FIG. 2 depicts an embodiment of an injector in accordance with the invention;

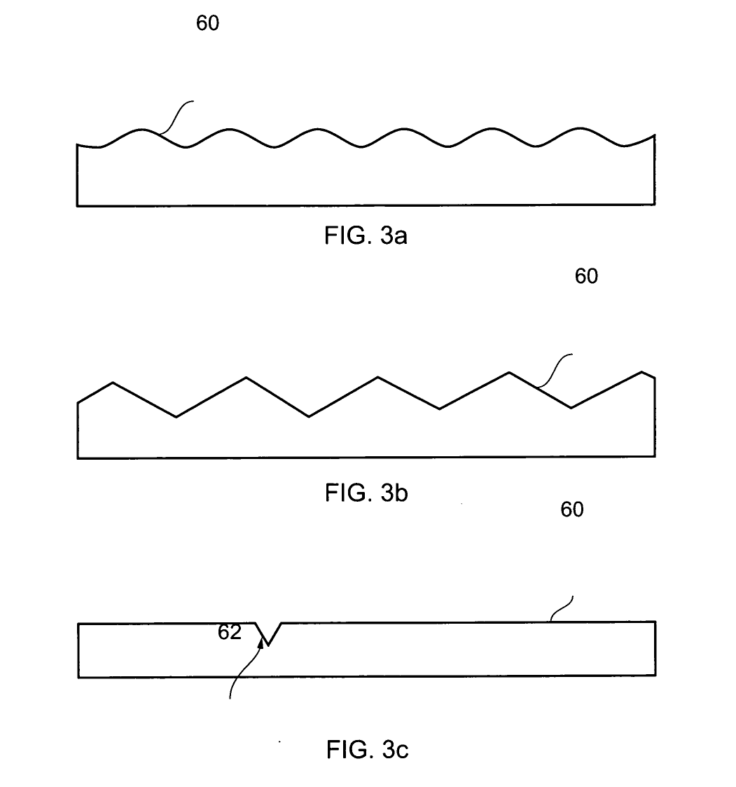

FIG. 3a depicts an embodiment of the injector with an elongate splitter; FIG. 3b depicts a further embodiment of the invention;

FIG. 3c depicts a further embodiment of the invention;

With reference to FIG. 1, a ducted fan gas turbine engine generally indicated at 110 comprises, in axial flow series, an air intake 101, a propulsive fan 102, an intermediate pressure compressor 103, a high pressure compressor 104, combustion equipment 105, a high pressure turbine 106, an intermediate pressure turbine 107, a low pressure turbine 108 and an exhaust nozzle 109.

Air entering the air intake 101 is accelerated by the fan 102 to produce two air flows, a first air flow into the intermediate pressure compressor 103 and a second air flow that passes over the outer surface of the engine casing 112 and which provides propulsive thrust. The intermediate pressure compressor 103 compresses the air flow directed into it before delivering the air to the high pressure compressor 104 where further compression takes place.

Compressed air exhausted from the high pressure compressor 104 is directed into the combustion equipment 105, where it is mixed with fuel injected through a fuel injector 17 mounted on an injector stalk 18 and the mixture combusted. The resultant hot combustion products expand through and thereby drive the high 106, intermediate 107 and low pressure 108 turbines before being exhausted through the nozzle 109 to provide additional propulsive thrust. The high, intermediate and low pressure turbines respectively drive the high and intermediate pressure compressors and the fan by suitable interconnecting shafts.

FIG. 2 shows a concentrically staged injector 17 in accordance with the invention. The injector has a central axis 2 that extends generally parallel with the main axis, X-X- of FIG. 1, of the engine. A pilot injector 10 is arranged around the axis 2 to inject fuel primarily at low power usage but also some fuel, along with the main injector, at higher power usage. The injector in this embodiment is an airblast injector having a bore 12 defined by a fuel housing 8 the inner surface of which provides a prefilmer surface 14 to which fuel is supplied from passages within the fuel housing. A centrebody 4 in the bore 12 supports an array of axial swirl vanes 6 that impart swirl to a flow of air through the bore 12 and over the prefilmer surface 14. The air flow is accelerated by the swirl vanes and the imparted tangential momentum directs the flow over the prefilmer such that there is no separation of the boundary layer. The fuel supplied to the prefilmer 14 by slots 16 is accelerated by the swirling air flow and carried as a film to the prefilmer lip where it is atomised.

The fuel housing 8 provides separation between the bore 12 and the outer swirl passage 22 and provides the outer surface of the bore 12 and the inner surface of the outer swirl passage 22. Fuel passages (not shown) in the fuel housing have swirl vanes to impart a swirling motion to the fuel before it is supplied to the prefilmer 14. Beneficially, the fuel is provided to the surface 14 with a uniform distribution.

The outer swirler passage 22 is provided with an elbow 23 that gives a strong area contraction to increase the peak velocity of the air flow. The generated high velocity, swirling flow interacts with the atomised fuel to produce a well dispersed fuel and air mixture.

The pilot injector must provide a stable flame throughout the operating range of the combustor. Stability can be improved by operating the injector in a rich mode i.e. more fuel than stoichiometrically required. However, operating the combustion rich can give rise to the generation of smoke and unburned hydrocarbons as well as excessive fuel usage. Operating the combustion lean can result in too much air and problems of weak extinction. Typically 8 percent to 20 percent of combustor air passes through the pilot injector.

Airspray pilot injectors offer advantages over simple pressure-jet injectors. For example, they generally give less smoke at high pressures than a pressure jet and also offer improved ignition during re-light because of more complete atomisation.

The flame produced by the pilot injector is protected from a main injector air flow by a splitter 25. The splitter is arranged as an outboard cone. The main injector is located radially outside the pilot injector. The main injector has a radially inner swirl passage 38 defined between the radially outer surface 28 of the splitter and the radially inner surface of the main fuel housing. The inner main swirl passage 38 has an array of inner swirl vanes 42 that swirls the main flow of air. Approximately 50 percent of combustor air passes through the inner swirl passage 38.

The fuel housing defines a prefilmer 46 and supports a fuel supply that opens into an annular swirl slot in the prefilmer face. Fuel is supplied as a film to the prefilmer and remains as a film to the prefilmer lip 48 where it is atomised in the swirling air flow. An outer swirl passage 52 is located radially outside the fuel housing and an array of swirlers 54 generate swirling flow that mixes with the atomised fuel to create a highly dispersed air and fuel mixture.

The main injector provides fuel to the combustor at high power loadings with the fuel being ignited by the pilot flame. It is desirable to control the manner in which the pilot flame and the main combustion zone interact. To vary the interaction between the pilot and main zone the splitter is provided with a profiled edge such that it has an axial length which varies around the circumference of the splitter.

FIGS. 3a-3c depicts the splitter in an unwrapped view i.e. the annular component is opened up and laid out flat. In FIG. 3a the downstream edge 60 defines arcuate portions thus providing a smoothly varying downstream edge the profile may be sinusoidal or other curve profile. This edge profile provides a high degree of variability. Other similar profiles comprise a saw-tooth shaped downstream edge shown in FIG. 3b.

FIG. 3c depicts an alternative arrangement where the edge profile has a notch 62 Which locally accelerates mixing and the interaction between the pilot and main zones. One of the further benefits of this arrangement has been an improved light round reliability in which the discrete discontinuity and locally accelerated mixing helps to promote flame kernel transfer between adjacent injectors.

Various modifications may be made without departing from the scope of the invention. In particular, components described with respect to one or more of the embodiments may be interchangeable with similar components described in other embodiments.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A fuel injector head for a gas turbine engine comprising: a pilot injector having a central axis, the pilot injector being arranged to direct fuel and air to a pilot combustion zone, a main injector located radially outwardly of the pilot injector and being arranged to direct fuel and air to a main combustion zone, a splitter separating the pilot injector from the main injector and comprising a body, the body defining an axis, an annular surface and a downstream edge wherein the annular surface has a circumferentially varied axial length so that interaction between the pilot combustion zone and the main combustion zone initiates from least two different axial positions.

2. A fuel injector head according to claim 1, wherein the downstream edge is of a generally sinusoidal form.

3. A fuel injector head according to claim 1, wherein the downstream edge is of a form which defines arcuate portions.

4. A fuel injector head according to claim 1, wherein the downstream edge has a notch.

5. A combustor having a plurality of injectors according to claim 4.

6. A method of promoting flame kernel transfer between adjacent injectors in a combustor according to claim 5, the combustor having a circumferential swirl flow pattern, the method comprising the step of locating the notch in a circumferential position around at least one of the injectors to induce locally accelerated mixing between the pilot and main zones of the injector which is convected by the circumferential swirl flow pattern to an adjacent injector.
